(19) United States
(12) Patent Application Publication
(10) Pub. No.: US 2004/0186020 A1
(43) Pub. Date: Sep. 23, 2004

(54) Compositions for preserving the appearance of floral material and method of use thereof

(76) Inventors: Richard J. Hinrichs, Fallbrook, CA (US); Cyrus A. Jaffari, Pine Valley, CA (US)

Correspondence Address: GORDON & REES LLP, 101 WEST BROADWAY, SUITE 1600, SAN DIEGO, CA, 92101, US

(21) Appl. No.: 10/801,621

(22) Filed: Mar. 16, 2004

Related U.S. Application Data
(60) Provisional application No. 60/456,083, filed on Mar. 19, 2003.

(51) Int. Cl. A01N 3/02; A01N 25/00

(52) U.S. Cl. 504/115

(57) ABSTRACT

Aqueous polymer latex compositions are disclosed which can be applied as by spraying to the surfaces of cut or live floral and foliage displays and which maintains the appearance of such displays substantially unchanged for an extended period of time following application. Displays thus retain their appearance throughout the length of an event or for some time following delivery to a person. The compositions maintain the appearances of the displays notwithstanding adverse conditions such as the display being in a high heat or low humidity atmosphere. The method of maintaining the appearance by application of the compositions to the plant surfaces is also disclosed.

### CROSS-REFERENCE TO RELATED APPLICATION

This application claims the benefit of the filing date of provisional patent application Ser. No. 60/456,083, filed on Mar. 19, 2003.

### BACKGROUND OF THE INVENTION

### FIELD OF THE INVENTION

The invention herein pertains to handling and maintenance of floral displays.

### BACKGROUND OF THE INVENTION

Cut flowers are commonly used in floral displays or bouquets, which may be for personal or commercial use or a combination of the two. Personal uses include a display of bouquet which one might send to a friend or loved one to celebrate an event such as a birthday or offer condolences or wishes such as when there is a death in a family or for recovery of someone from an illness or injury, and the like. Commercial uses include the use of cut flowers in displays such as on floats in parades or in commercial or public events such as in business offices, at awards ceremonies, at gala events such as business parties or dances, and the like. Combination uses include having commercial florists provide displays for personal or family events, such as the floral displays that are used at weddings, family banquets, family religious ceremonies such as confirmations or bar/bat mitzvahs. Many other events and occasions at which cut floral displays are used will come readily to mind.

A major problem for cut floral displays is service life, generally considered to be measured as the time after cutting of the flowers and associated greenery before the displayed flowers and greenery begin to wilt and take on a less attractive appearance. Of course when a live flower or other plant is cut, it immediately thereupon no longer is self-sustaining and will ultimately deteriorate. Florists, both commercial and individual, have developed many techniques to keep cut flowers attractive for limited times, such as putting their cut stems in water-filled vases, often with additives put into the water to be taken up through the stems and prolong the desired appearance of the display. In commercial florist shops, supermarkets, or elsewhere where cut displays are sold, they are often kept temporarily in chilled enclosures, since cool temperatures retard the deterioration of the foliage. In many cases, however, such techniques are either insufficient or not possible to use to maintain the display appearance over a prolonged period.

Extension of cut flower usage periods is important in at least two significant situations. First, when persons receive displays or bouquets as gifts or as expressions of friendship, sympathy or concern they often wish to keep them in their homes, hospital rooms, etc. for as long as possible because looking at them evoked pleasant feelings. Similarly, when companies or other commercial or social groups purchase floral displays, they naturally want to obtain the maximum display time from them. Second, in many instances flowers must be cut and floral displays created well in advance of their actual use, and it is desired to have them retain their fresh appearance until their use and usually for some prolonged period of use. For instance, floats for a parade must be constructed well in advance of the date of the parade, so the flowers must be cut and applied to the floats at that earlier time but still look fresh and crisp on the day of the parade. In many cases the parade organizers place the floats on public display for a few days after the parade, which means that the cut flowers must retain their appearance for an even longer time.

Another significant situation in which floral displays must be maintained with a fresh appearance in an adverse environment is the use of floral displays in awards or similar ceremonies, where usually there is an elevated temperature level because of the presence of extensive high-powered lighting, such as when such ceremonies are being televised or when the displays are used in theatrical productions. Similarly, in environments where the humidity is low, foliage tends to wilt. In cases such as highly lighted events, the heat of the lights often also acerbates the dryness of the ambient air, thus compounding the floral deterioration problem.

In many such circumstances such conventional foliage appearance extension techniques such as immersion in water cannot be used, either because there is no facility for placing vases or other water-filled containers or because other activities at the venue are such that there is an unacceptable risk of breakage of the containers, spilling of the water, or the like.

There is also a related situation with cut flowers and foliage which has heretofore defied solution. Flowers and foliage are normally cut when they are the peak of their appearance, since the person when collecting the flowers or greenery is naturally looking for the best appearing plants. However, cutting of course begins the plant's deterioration. Even though the techniques mentioned above may be undertaken it has not heretofore been possible to preserve that fresh-cut appearance of the plant. In other words, one has not heretofore been able to “capture” that peak appearance of the plant.

Many of the same problems arise, to a different extent, with live potted plants and displays. Live plants can deteriorate under adverse environmental conditions, such as strong lights and drying atmospheres. It would be beneficial to have a way of maintaining moisture content in living plants, in order to preserve their fresh appearance.

There has therefore been a long-felt need for a coating material which, when applied to floral displays and similar cut foliage, would cause the service or appearance life of the display or foliage to be extended for a significant period, notwithstanding the presence of a dry and/or warm environment. Heretofore such coating materials as have been available have had little success. For instance, they have been difficult to apply, did not produce more than minimal extension of foliage appearance life, did themselves detract from the foliage appearance (such as by producing a clouded appearance on the foliage), or for many other reasons or combinations of such reasons.

There has also been a need for means for maintaining the same appearance of a floral or foliage display for an extended period of time. It would be highly desirable to have a means by which the optimum appearance of the display could be “locked in” or “frozen”. This would allow one to preserve individual cut plants as well as of displays of combinations of plant at their peak appearance, and thereafter maintain that appearance throughout, for instance, the length of an entire event such as a banquet, awards ceremony or wedding.

Further, there has been a need for a composition which would maintain the appearance of a live, especially potted, plant under adverse conditions of heat and dryness. This would allow one to keep a live plant fresh-appearing even under such conditions.

### SUMMARY OF THE INVENTION

The invention herein is of compositions which may be applied to foliage and which will significantly extend the display or appearance life of the foliage, while maintaining the foliage in its configuration as of the time at which the compositions were applied. The compositions may be applied by coating with an applicator, sprayed directly onto the foliage as a stream or mist or allowed to deposit onto the foliage from the ambient atmosphere by placing a floral display or cut foliage in an enclosed space in which the atmosphere contains the compositions as a aerosols, preferably at or near the saturation level in the enclosure atmosphere. The compositions have been found to provide quite extended life for foliage, even in the presence of television lights or other adverse environments, such as low humidity environments. They have also been found to be able to capture and preserve peak appearance of the flowers or foliage for extended periods.

The compositions are particularly suited for use with cut foliage, but they also find utility with preserving the appearance of live plants and plant displays, especially under adverse conditions such as heat and/or dryness.

Specifically, the compositions are comprised of a polymer latex component, a component comprising plant nutrients or protectants, and a coating formation adjuvant component, with the balance being an aqueous carrier (usually a purified water) in which all of the other components are dissolved or suspended. Preferably the polymer latex will comprise about 3%-30% of the composition, the nutrient/protectant component will comprise about 0.1%-7.0% of the composition, the coating adjuvant component will comprise about 0.05%-2.0% and the balance to 100% will be water. (All percentages herein are by weight unless otherwise stated.)

Therefore, in one principal embodiment, the present invention is of a composition for maintaining or prolonging the appearance of a floral or foliage display comprising a polymer latex, a nutrient/protectant component, a coating adjuvant component and the balance water, which composition maintains or prolongs the appearance upon application to surfaces of cut plants of the display.

In another principal embodiment, the present invention is of a composition for maintaining or prolonging the appearance of a floral or foliage display comprising a polymer latex, a nutrient/protectant component, a coating adjuvant component and the balance water, which composition when applied to surfaces of cut plants of the display retains an appearance of the display substantially the same as its appearance at the time of application of the composition, retention of the appearance extending over Han prolonged period of time or extends for a prolonged period of time the service life of the display, the service life comprising maintenance of an acceptable appearance of the display without significant onset of wilting.

In yet another principal embodiment, the present invention is of a method for maintaining or prolonging the appearance of a floral or foliage display which comprises applying to surfaces of cut plants of the display a composition comprising a polymer latex, a nutrient/protectant component, a coating adjuvant component and the balance water.

In yet another principal embodiment, the present invention is of a method for maintaining or prolonging the appearance of a floral or foliage display which comprises applying to surfaces of cut plants of the display a composition comprising a polymer latex, a nutrient/protectant component, a coating adjuvant component and the balance water, whereby following application the display retains an appearance substantially the same as its appearance at the time of the application over a prolonged period of time or the service life of the display is extended for a prolonged period of time, the service life comprising maintenance of an acceptable appearance of the display without significant onset of wilting.

The compositions of this invention have the unique property of actually freezing the shape and condition of the flower or other foliage at the time of spraying. Essentially they inhibit the natural maturation and aging of the flower so the applicator can choose at what stage in the flower's budding life cycle to capture the appearance and hold it for an extended period of time while refreshing the flower (hydration, nutrition, biocide protection, etc.). Thus if one visualizes a rose at a “perfect” configuration this product freezes it at that stage so the user can elect at what stage is most beneficial to apply it. The compositions are applied onto the exposed surface of the flower or foliage, not mixed into any water the foliage may be placed in.

The compositions of this invention find particular utility in prolonging the appearance of cut flowers and other floral and foliage displays. These may encompass not only flowers but also greenery such as wreaths, scrubs, boughs and trees, such as Christmas trees. In addition, the compositions find utility in preserving the appearance of live plants, especially potted plants, under adverse environmental conditions such as heat and dryness.

The compositions of this invention may be used with many different types of flowers and other foliage. Most commonly they will be used to maintain displays of roses, mums, dahlias, carnations, lilies or iris, but many other flowers, or foliage or greenery, especially of the types used in displays as surround materials against which the more prominent elements of the display (usually the flowers) may be set off to produce the desired visual impact. Other types of plant and greenery material, such as mentioned in the preceding paragraph, can also be used. It is to be understood that the mention here of specific types of plants is not meant to be limited, but merely to be exemplary of the many types of plants, cut and live, which can have their appearances enhanced by the application of the present compositions. Those skilled in the art will recognize many other types of plants whose appearance can benefit from the present compositions.

Other embodiments including numerous variations will be evident from the disclosure herein.

### DETAILED DESCRIPTION AND PREFERRED EMBODIMENTS

In the specification and claims herein, the terms “flower”, “floral” and “foliage” will frequently be used as functional synonyms or in combination, and intended to encompass all of the plants which are used in displays, whether cut or live. “Flowers” and “floral” may also be used in a more limited sense to refer to flowers and ferns, while “foliage” may also include greenery, which for the purposes herein may be considered to include cut and live vegetative materials of the types used in displays as surround materials against which the more prominent elements of the display (usually the flowers) may be set off to produce the desired visual impact, as well as green plants which are “stand alone” plants, such as shrubs and trees. The use of either or both “floral” or “foliage” is not intended to limit in any way the overall scope of the invention, which is applicable to all types of vegetative displays.

The polymer latex is the principal component of the compositions. Numerous types of polymer latexes are acceptable. The particular latex selected must rapidly and substantially completely spread as a thin coating film over the surface of the foliage, such as across the surface of a leaf or a flower petal, without significantly changing the shape of the leaf or petal, discoloring it, or otherwise detracting from the natural appearance of the foliage, and then must rapidly set so as to maintain the appearance of the flowers or display in that configuration that existed at the time of coating. It is preferred that the latex be formed from a non-rubber polymer; the rubber latexes do not normally form sufficiently thin coatings to allow maintenance of the natural appearance of the foliage. Further, the coating must be such that if the plant is live, the coating with eventually come off the plant surfaces, either spontaneously or by being wiped off by a cleaner or solvent, without ultimate harm to the live plant.

Numerous polymer latexes formed from synthetic (non-rubber) polymers are useful in the present invention. Particularly preferred are the acrylic and methacrylic polymer latexes and combinations thereof, such as vinyl acrylic, styrene butadiene, halogen tagged acrylic and styrene acrylic copolymer latexes. Other types of polymers which form suitable latexes include the vinyl and vinyl alcohol polymers Commercial latexes have various flexibility and coverage properties; it will be recognized that not all polymers within a class will form suitable latexes for the compositions of the present invention. However, those skilled in the art will readily be able to select the latex(es) with the optimum properties for treating the particular displays of their interest from the many commercial materials, all of which are described in detail in the various manufacturers' technical data sheets and other information sources. The polymer latex will be present in a concentration of about 3%-30% of the composition, more preferably about 3%-10%, and yet more preferably, about 4%-8%. A particularly preferred polymer latex is one commercially available from the Goodyear Chemical Co. under the designation “Carboset® 514H”.

The second critical component of the composition is one which provides nutrients and/or protection to the foliage. Nutrients for the purposes of this invention are those materials which, when delivered to a living plant, are known to provide nourishment. Protection materials (or “protectants”) are materials which are known to act to lessen adverse conditions for plants, such as by reducing or eliminating the presence of plant insect, microbial or other pests, inhibit the formation or secretion of debilitating chemicals or biological materials from or by the plant, or shield the plant from contact with adverse materials which may be present in the ambient environment of the plant. With live plants the mechanisms are believed to relate to the provision of nutrients to the plant, even while it is under stress, such as from heat and/or dryness, and to the ability of the coating to retain moisture within the plant by restricting the evaporation or transpiration of water from within the plant. The exact mechanism of the function of these materials is not known with respect to cut foliage to the same degree that it may be understood for live plants. However, and without intending to be bound by any conjecture about mechanism, it is believed that the cut foliage may retain some ability to absorb the nutrient materials through the foliage surfaces and for the remaining parts of the plant to metabolize those absorbed materials to some extent. This is believed to decrease the rate of deterioration of the cut foliage. Similarly, and again without intending to be bound by conjecture, it is believed that the protectant materials may act with respect to the cut foliage in substantially the same way as with live plants, in that they remove harmful pests, chemicals, etc. from the surfaces of the foliage and/or block contact with the foliage surfaces by chemicals, biocides, ambient gases, other liquids, or particulate air- or water-borne materials for which contact would be deleterious for the foliage.

Among the materials which are considered to be within the nutrient/protectant component are materials commonly known as antimicrobial or antifungal agents, nourishing agents, germicides, gas production inhibitors (such as ethylene production inhibitors), anti-oxidants, plant oils and the like. It will be recognized that many of the commercial products within these classes are proprietary products whose precise formulas are known only to their manufacturers; examples are listed below by their commercial designations. Those skilled in the art can readily identify these classes of products by their functionality and select from commercial products within each class and sold for such functions. Typical examples include:

| | |
|---|---|
| Antimicrobial or | A mixture of 1,2-benzisothiazolin-3-one and |
| antifungal agents: | proylene glycol sold under the designation |
| | “Troysan ™ 586” by G. R. O'Shea Co. |
| Nourishing agents: | Sucrose or other sugars |
| Germicides: | Quaternary ammonium salts; 8-hydroxyquinoline |
| | sulphates or citrates; thiobendazoles |
| Ethylene inhibitors: | Carbon dioxide; aminooxyacetic acid; silver |
| | thiosulfates |
| Anti-oxidants: | Vitamin E; liquid p-phenylene-diamine derivatives |
| | sold under the designation Wingstay ®, e.g., |
| | “Wingstay ® S” liquid, by Goodyear Chemical Co. |
| Plant oils: | Glycerin, aloe |

These materials commonly are used in the following concentrations:

| | |
|---|---|
| Antimicrobial or antifungal agents | 0.05%-0.8% |
| Nourishing agents | 0.01%-2.0% |
| Germicides | 0.001%-0.2% |
| Ethylene inhibitors | 0.01%-0.8% |
| Antioxidants | 0.05%-0.8% |
| Plant oils | 0.2%-2.0% |

It will be recognized that these concentrations can be varied and that mixtures of different products will be proportional within the total concentration for each class of product. The overall total concentration of the nutrient/protectant component of the compositions will be on the order of 0.1%-7.0%.

The third component of the compositions of this invention is composed of materials which function as coating adjuvants, that is, which enhance or assist in the formation or spread of the polymeric film, prevent foam from forming in the composition liquid, and the like. Suitable materials which enhance or assist in the formation or spread of the polymeric film are surfactants and wetting agents, which when included in the compositions reduce surface tension of the latex liquid and/or condition the surfaces of the foliage so that the latex compositions spread and flow evenly and smoothly over the foliage surfaces without distorting them. There are many types and formulations of surfactants and wetting agents, and their various chemistries and properties are well known and widely described. Those skilled in the art will have no difficulty selecting optimum surfactants or wetting agents for their particular foliage of interest from the many commercial products available. Similarly defoamers are well known and readily available, and may easily be selected for specific properties desired, depending on the tendency of the latex in use to foam. Specific examples of suitable products are, as a surfactant, an aqueous solution of an ammonium salt of an acrylate copolymer sold under the designation BYK®156 by BYK-Chemie, and of a defoamer, polypropylene glycols, polyglycol polymers, glycerides or silicones, such as a water dilutable silicone emulsion sold by Dow Corning Corporation under the designation “Antifoam B.” The normal concentrations of the surfactants or wetting agents will be on the order of 0.05%-1.5% of the compositions and concentrations of the defoamers will be on the order of 0.001%-0.02% of the compositions, such that the total concentrations of the coating adjuvant component will be on the order of 0.05%-2.0% of the compositions.

The balance of the compositions to 100% will be composed of water, preferably a deionized or otherwise purified water. The compositions may be prepared by simply blending the components using the techniques common to aqueous polymer latex formulation manufacture. No special handling or formulation is required other than whatever precautions are normally taken to avoid mixing incompatible materials and to accommodate any known hazards or peculiarities of the materials selected.

The compositions are normally applied by spraying onto the surfaces of the flowers or other foliage. The stems of the flowers or foliage may or may not be immersed in water or be rooted in soil, such as potting soil within a container. The spraying is conducted at the time selected by the user of the compositions and will depend on the appearance desired and the particular cut flowers or foliage in the displays of interest. The spray should be sufficiently thin to spread rapidly and evenly and flow into the various recesses of the foliage and flowers but not so thin that significant portions are lost prior to formation of the coating film or significant surfaces of the foliage are left uncoated. It has been found that use of present compositions will maintain and/or prolong the appearance of the plants, whether cut or live, for at least about 20% longer than has heretofore been possible with the products and techniques of the prior art. Those skilled in the art will be readily able to determine the desired spray rate, runoff recovery and film formation by routine minimal trials.

As noted, the compositions of this invention may be used with many different types of flowers and other foliage. Most commonly they will be used to maintain displays of roses, mums, dahlias, carnations, lilies or iris, but many other flowers and ferns and other types of foliage or greenery such as shrubs, boughs or tress (such as Christmas trees) can also be suitably treated with these compositions.

As an example, a composition of the following formula was formed:

| | | |
|---|---|---|
| Goodyear 514H polymer latex | | 6.0% |
| Nutrients/protectants | | |
| Troysan 586 antimicrobial/ | 0.18% | |
| antifungal agent | | |
| Methocel ® methylcellulose | 0.04% | |
| BYK ® 156 (portion as | (0.20%)* | 0.42% |
| ethylene inhibitor) | | |
| Adjuvants: | | |
| BYK ® 156 (remainder as | (0.20%)* | |
| surfactant) | | |
| Dow Antifom B defoamer | 0.0015% | 0.20% |
| Water (balance) | | 93.38% |
| Total: | | 100.00% |

(*Only one quantity of BYK ® 156 product is incorporated into the composition of this example. Allocation of its dual function is designated arbitrarily as shared equally, but the true allocation is not believed to be capable of determination.)

Quantities of this formulation were used to spray a large number of floral/foliage displays which were used in a major televised awards ceremony, which was scheduled to run for at least three hours. Various types of flowers and greenery were used in the displays. Requirements for pre-placement of all displays well before broadcast time for the ceremony demanded that all floral/foliage displays be sprayed 8-12 hours prior to broadcast time. The floral/foliage displays sprayed with the composition of this invention retained their desired fresh appearance without significant change entirely from the time of spraying until well after the conclusion of the ceremony. Numerous knowledgeable persons involved with the production and broadcasting of the ceremony observed the sprayed displayed before, during and after the ceremony and remarked favorably on how well the displays had maintained their original appearance notwithstanding the long time following the spraying.

It will be evident that there are numerous embodiments of the present invention which are not expressly identified herein, but which are clearly within the scope and spirit of the invention. The above descriptions should therefore be considered to be exemplary only, and the full scope of the invention is to be determined solely from the appended claims, as they may be interpreted from the specification.

We claim:

1. A composition for maintaining or prolonging the appearance of a floral or foliage display comprising a polymer latex, a nutrient/protectant component, a coating adjuvant component and the balance water, which composition maintains or prolongs said appearance upon application to surfaces of cut plants of said display.

2. A composition as in claim 1 wherein said polymer latex comprises a latex of acrylic, methacrylic, vinyl acrylic, halogen tagged acrylic, styrene acrylic, styrene butadiene, vinyl or vinyl alcohol polymers or combinations thereof.

3. A composition as in claim 2 wherein said polymer latex comprises a latex of acrylic or methacrylic polymers or combinations thereof.

4. A composition as in claim 1 wherein said polymer latex is present in said composition in a concentration on the order of 3%-30% of said composition.

5. A composition as in claim 4 wherein said polymer latex is present in said composition in a concentration on the order of 3%-10% of said composition.

6. A composition as in claim 5 wherein said polymer latex is present in said composition in a concentration on the order of 4%-8% of said composition.

7. A composition as in claim 1 wherein said nutrient/protectant component comprises an antimicrobial agent, antifungal agent, nourishing agent, germicide, ethylene inhibitor, anti-oxidant or plant oils or mixtures thereof; said nourishing agent comprises a sugar; said germicide comprises an ammonium salt, an 8-hydroxyquinoline sulphate or citrate or a thiobendazole; said ethylene inhibitor comprises carbon dioxide, aminooxyacetic acid or a silver thiosulfate; said anti-oxidant comprises vitamin E or a liquid p-phenylene-diamine derivative; or said plant oil comprises glycerin or aloe.

8. A composition as in claim 7 wherein said antimicrobial agent or said antifungal agent comprises a mixture of 1,2-benzisothiazolin-3-one and proylene or said nourishing agent comprises sucrose.

9. A composition as in claim 1 wherein said nutrient/protectant component is present in said composition in a concentration on the order of 0.1%-7.0% of said composition.

10. A composition as in claim 1 wherein said coating adjuvant component comprises a surfactant, a wetting agent or a defoamer.

11. A composition as in claim 10 wherein said coating adjuvant component is present in said composition in a concentration on the order of 0.5%-2.0% of said composition.

12. A composition as in claim 1 wherein said floral or foliage display comprises roses, mums, dahlias, carnations, lilies, ferns, iris or greenery.

13. A composition as in claim 1 wherein said floral or foliage display comprises cut plants.

14. A composition as in claim 1 wherein said floral or foliage display comprises live plants.

15. A composition for maintaining or prolonging the appearance of a floral or foliage display comprising a polymer latex, a nutrient/protectant component, a coating adjuvant component and the balance water, which composition when applied to surfaces of cut plants of said display retains an appearance of said display substantially the same as its appearance at the time of application of said composition, retention of said appearance extending over an prolonged period of time or extends for a prolonged period of time the service life of said display, said service life comprising maintenance of an acceptable appearance of said display without significant onset of wilting.

16. A composition as in claim 15 wherein said polymer latex comprises a latex of acrylic, methacrylic, vinyl acrylic, halogen tagged acrylic, styrene acrylic, styrene butadiene, vinyl or vinyl alcohol polymers or combinations thereof.

17. A composition as in claim 16 wherein said polymer latex comprises a latex of acrylic or methacrylic polymers or combinations thereof.

18. A composition as in claim 15 wherein said polymer latex is present in said composition in a concentration on the order of 3%-30% of said composition.

19. A composition as in claim 18 wherein said polymer latex is present in said composition in a concentration on the order of 3%-10% of said composition.

20. A composition as in claim 19 wherein said polymer latex is present in said composition in a concentration on the order of 4%-8% of said composition.

21. A composition as in claim 15 wherein said nutrient/protectant component comprises an antimicrobial agent, antifungal agent, nourishing agent, germicide, ethylene inhibitor, anti-oxidant or plant oils or mixtures thereof; said nourishing agent comprises a sugar; said germicide comprises an ammonium salt, an 8-hydroxyquinoline sulphate or citrate or a thiobendazole; said ethylene inhibitor comprises carbon dioxide, aminooxyacetic acid or a silver thiosulfate; said anti-oxidant comprises vitamin E or a liquid p-phenylene-diamine derivative; or said plant oil comprises glycerin or aloe.

22. A composition as in claim 21 wherein said antimicrobial agent or said antifungal agent comprises a mixture of 1,2-benzisothiazolin-3-one and proylene or said nourishing agent comprises sucrose.

23. A composition as in claim 15 wherein said nutrient/protectant component is present in said composition in a concentration on the order of 0.1%-7.0% of said composition.

24. A composition as in claim 15 wherein said coating adjuvant component comprises a surfactant, a wetting agent or a defoamer.

25. A composition as in claim 24 wherein said coating adjuvant component is present in said composition in a concentration on the order of 0.5%-2.0% of said composition.

26. A composition as in claim 15 wherein an anticipated period of time of preserved appearance is increased by at least 20%.

27. A composition as in claim 15 wherein said floral or foliage displays comprise roses, mums, dahlias, carnations, lilies, ferns, iris or greenery.

28. A composition as in claim 15 wherein said floral or foliage display comprises cut plants.

29. A composition as in claim 15 wherein said floral or foliage display comprises live plants.

30. A method for maintaining or prolonging the appearance of a floral or foliage display which comprises applying to surfaces of plants of said display a composition comprising a polymer latex, a nutrient/protectant component, a coating adjuvant component and the balance water.

31. A method as in claim 30 wherein said applying comprises spraying said composition onto said surfaces of said plants.

32. A method as in claim 30 wherein said floral or foliage display comprises cut plants.

33. A method as in claim 30 wherein said floral or foliage display comprises live plants.

34. A method for maintaining or prolonging the appearance of a floral or foliage display which comprises applying to surfaces of plants of said display a composition comprising a polymer latex, a nutrient/protectant component, a coating adjuvant component and the balance water, whereby following application said display retains an appearance substantially the same as its appearance at the time of said application over a prolonged period of time or the service life of said display is extended for a prolonged period of time, said service life comprising maintenance of an acceptable appearance of said display without significant onset of wilting.

35. A method as in claim 34 wherein said applying comprises spraying said composition onto said surfaces of said plants.

36. A method as in claim 34 wherein said floral or foliage display comprises cut plants.

37. A method as in claim 34 wherein said floral or foliage display comprises live plants.
